(19) United States
(12) Patent Application Publication
(10) Pub. No.: US 2004/0050435 A1
(43) Pub. Date: Mar. 18, 2004

(54) Novel method of creating micro-structures for micro-fluidic applications

(76) Inventors: Mark A. Hayes, Tempe, AZ (US); Antonio A. Garcia, Tempe, AZ (US); Nolan A. Polson, Longmont, CO (US)

Correspondence Address: Pitney Hardin Kipp & Szuch, 685 Third Avenue, New York, NY, 10017, US

(21) Appl. No.: 10/296,483

(22) PCT Filed: May 23, 2001
(86) PCT No.: PCT/US01/16764

(30) Foreign Application Priority Data
May 23, 2000 (US) 60206478

(51) Int. Cl. G05D 7/03

(52) U.S. Cl. 137/827

(57) ABSTRACT

A method for assembling a pattern of structures in a microchannel comprises providing a colloid of paramagnetic particles in a microchannel and applying an axially uniform magnetic field thereto.

### SPECIFICATION

This invention relates to a method for assembling particles in microchannels to form a pattern of three-dimensional microstructures. More particularly, this invention provides for assembling paramagnetic particles into a pattern of three-dimensional structures in a microchannel using an external magnetic field.

### BACKGROUND OF INVENTION

Fluids flowing in microchannels have been used to prepare microchips which can be used in a number of applications. For example, the microchips can allow for analysis of very small quantities of complex biological samples and environmental samples, essentially providing the capabilities of a chemical laboratory on a microchip. Microchips can also be used to prepare optical gratings and photon masks.

The microchips include a plurality of microchannels which are etched onto a substrate. The microchannels on the microchip are typically between 5 and 200 μm in width and depth. The microchips are manufactured by exposing photoresist on silicon or glass followed by chemical etching. Other manufacturing techniques such as injection molding and hot embossing of plastic and polymers have also been used. These manufacturing techniques provide for permanent static patterning of the microchip.

Accordingly, there is a need for development of micro-fabrication techniques that are inexpensive, dynamic and flexible which can be used in microchip technology.

### SUMMARY OF THE INVENTION

An object of the invention is to provide a method for assembling particles to form dynamic and reversible spaced structures.

Another object of the invention is to provide a method for inducing micron-scale patterns which can be formed and reformed spontaneously.

A further object of the invention is to provide dynamic supraparticle patterning which can be used for on-chip applications and for microfabrication of microchips.

These and other objects of the invention are achieved by providing a plurality of paramagnetic particles in a microchannel and subjecting the microchannel to an external magnetic field. The magnetic field which is uniform in the axial direction of the microchannel causes the particles to assemble to form a pattern of supraparticle structures. The structure can be rotated in the microchannel by varying the magnetic field without significant distortion of the supraparticle structures.

### BRIEF DESCRIPTION OF THE DRAWINGS

Further objects, features, and advantages of the invention will become apparent from the following detailed description taken in conjunction with the accompanying figures showing illustrative embodiments of the invention, in which:

FIGS. 1A and 1B are schematics indicating magnetic field direction in relation to supraparamagnetic structures in a cylindrical channel in accordance with the invention;

FIG. 2A is an optical microscopy image of a cylindrical microchannel containing a colloidal suspension of paramagnetic particles;

FIG. 2B is an optical microscopy image of the cylindrical microchannel in FIG. 2A which has been placed under an axially-homogenous magnetic field with no appreciable gradient oriented perpendicularly with the plane of the page;

FIG. 2C is an optical microscopy image of the cylindrical microchannel in FIG. 2A placed under an axially-homogenous magnetic field with no appreciable gradient oriented vertically, parallel with the plane of the page;

FIG. 2D is an optical microscopy image of the cylindrical microchannel containing the colloidal suspension of paramagnetic particles in FIG. 2C placed under an axially-homogenous magnetic field with no appreciable gradient oriented forty five degrees off vertical, parallel with the plane of the page;

FIG. 2E is an optical microscopy image of the cylindrical microchannel containing the colloidal suspension of paramagnetic particles in FIG. 2D placed under an axially-homogenous magnetic field with no appreciable gradient oriented horizontally parallel to the plane of the page;

FIG. 2F is an optical microscopy image of the cylindrical microchannel containing the colloidal suspension of paramagnetic particles in FIG. 2E after the axially-homogenous magnetic field is removed;

FIG. 3A is an optical microscopy image of a cylindrical microchannel containing a colloidal suspension of paramagnetic particles in FIG. 2B under pressure-induced flow;

FIG. 3B is an optical microscopy image of the cylindrical microchannel containing the colloidal suspension of paramagnetic particles in FIG. 3A taken approximately one second later;

FIG. 3C is an optical microscopy image of the cylindrical microchannel containing the colloidal suspension of paramagnetic particles of FIG. 3B taken approximately one second later;

FIG. 3D is an optical microscopy image of the cylindrical microchannel containing the colloidal suspension of paramagnetic particles in FIG. 3C immediately after removal of the magnetic field;

FIG. 3E is an optical microscopy image of the cylindrical microchannel containing the colloidal suspension of paramagnetic particles in FIG. 3D approximately one second later;

FIG. 4A is an optical microscopy image of a cylindrical microchannel containing a colloidal suspension of paramagnetic particles in the presence of an applied potential field;

FIG. 4B is an optical microscopy image of the cylindrical microchannel containing the colloidal suspension of paramagnetic particles in FIG. 4A taken at a time slightly later than the image in FIG. 4A;

FIG. 4C is an optical microscopy image of the cylindrical microchannel containing the colloidal suspension of paramagnetic particles in FIG. 4B taken at a time slightly later than the image in FIG. 4B;

FIG. 4D is an optical microscopy image of the cylindrical microchannel containing the colloidal suspension of paramagnetic particles in FIG. 4C upon removal of the magnetic field;

FIG. 4E is an optical microscopy image of the cylindrical microchannel containing the colloidal suspension of paramagnetic particles in FIG. 4D taken at a time slightly later than the image in FIG. 4D;

FIG. 5A is an optical microscopy image of the cylindrical microchannel containing the colloidal suspension of paramagnetic particles in the presence of a magnetic field;

FIG. 5B is a schematic illustration of a cross-section of the cylindrical microchannel in FIG. 5A;

FIG. 5C is a schematic illustration of a triangular microchannel containing the dilute colloidal suspension of paramagnetic particles;

FIG. 5D is a schematic illustration of a cross-section of the triangular microchannel containing the dilute colloidal suspension of paramagnetic particles in FIG. 5C;

FIG. 5E is a schematic illustration of an image of a rectangular microchannel containing a dilute colloidal suspension of paramagnetic particles;

FIG. 5F is a schematic illustration of an image of a cross-section of the rectangular microchannel containing the dilute colloidal suspension of paramagnetic particles in FIG. 5E;

FIG. 6 is a schematic illustration a photon mask apparatus;

FIG. 7A illustrates a prior art cell;

FIG. 7B illustrates a cell that has been introduced to an aqueous suspension of paramagnetic particles;

FIG. 7C illustrates a cell that has been introduced to the group of paramagnetic particles for a period of time;

FIG. 7D illustrates a cell with mitochondria that has bonded with at least a portion of the group of paramagnetic particles and has been placed under a magnetic field.

Throughout the figures, unless otherwise stated, the same reference numerals and characters are used to denote like features, elements, components, or portions of the illustrated embodiments. Moreover, while the subject invention will now be described in detail with reference to the figures, and in connection with the illustrative embodiments, changes and modifications can be made to the described embodiments without departing from the true scope and spirit of the subject invention as defined by the appended claims.

### DETAILED DESCRIPTION OF THE PREFERRED EMBODIMENTS

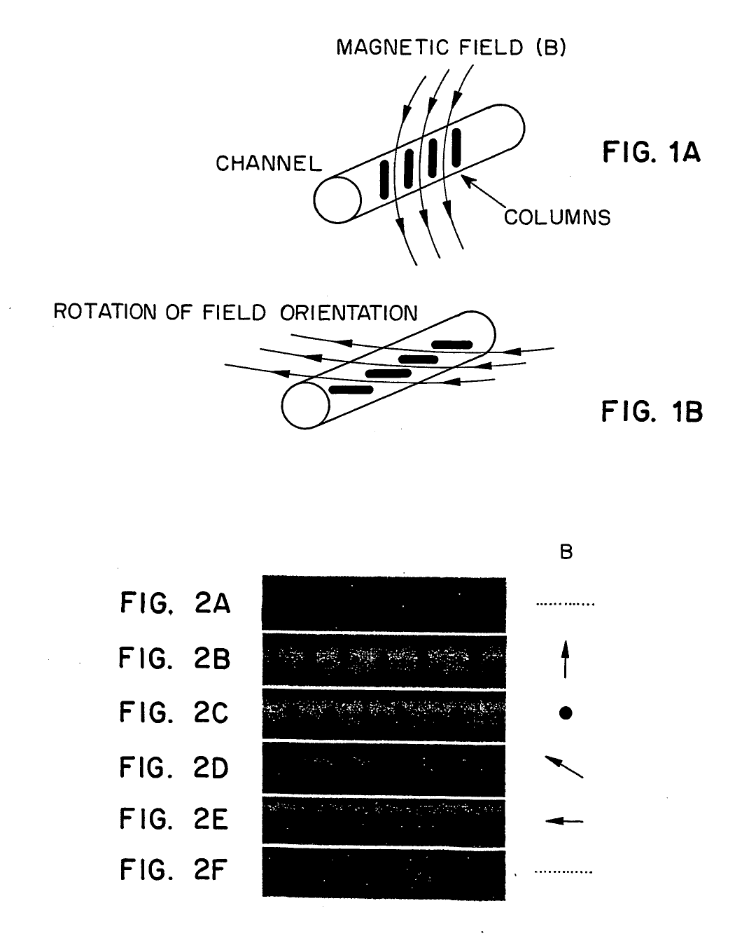

The present invention provides for the creation of dynamic and controllable three-dimensional microstructures by applying an external magnetic field to a colloid of solid paramagnetic particles constrained in a microchannel. Upon application of an external magnetic field which does not have an appreciable gradient in the axial direction of the microchannel, the particles assume a distinct columnar supraparticle structure as illustrated in FIGS. 1A and 1B. The basic structure of the pattern is a function of external field strength and orientation, the microchannel geometry and the colloid properties. By this method, the supraparticle patterning can be actively controlled at the macroscopic level. A zone of particles is initially formed by placing the magnet directly on the microchannel in order to locally sequester the particles. Fluid flow in the channel can be controlled either by applying a pressure gradient or through electroosmosis.

In marked contrast to reported magnetic particle behavior in macrosystems, these paramagnetic supraparticle structures show a number of striking properties. As a consequence of high magnetic flux and parallel field orientation, they respond rapidly and reversibly to changes in external field strength and orientation. The responsive structures move under electrokinetic and pressure pumping while retaining their structural integrity. Due to the surface charge on the solid particles, they return to a colloidal suspension when the magnetic field is removed. The small dimensions and geometry of the channel directly influences the location, spacing and conformation of the structures. The unique properties of this system have resulted in the discovery of truly dynamic and controllable structures in ultrasmall volumes, nanoliter to picoliter, which can be manipulated through a variety of mechanisms.

### EXAMPLE 1

Sodium dihydrogen phosphate (NaH₂PO₄) was obtained from Aldrich Chemical Co., Inc. (Milwaukee, Wis.) and was used as received. All NaH₂PO₄ buffers were prepared to a 20 mM concentration and adjusted to pH 7.0 using 1M sodium hydroxide (Mallinckrodt, Phillipsburg, N.J.). Paramagnetic particles 1 to 2 μm in diameters, coated with an amine functional group, containing greater than 20 wt. % of iron, and having a polystyrene surface matrix with amine groups were purchased from Polysciences, Inc. (Warrington, Pa.; catalog no. 18190) and used as received. Dynal paramagnetic particles (2.8 μm diameter, 1 mg/mL diluted 5× in phosphate buffered saline) were obtained from Nichols Institute Diagnostics (San Juan Capistrano, Calif.). Fused silica capillary (150 μm outer diameter/20 μm inner diameter) was purchased from Polymicro Technologies, Inc. (Phoenix, Ariz.) and cut to a 50.8 cm. length. All buffers and samples were prepared with 18M purified water drawn from a NANOpure UV ultrapure water filtration system (Barnstead, Dubuque, Iowa).

A vacuum/pressure chamber was used to induce pressure differentials across the fused silica capillary. Electroosmotic flow were generated using a capillary electrophoresis system using a CZE1000R high-voltage power supply (Spellman High Voltage Electronics Corporation. Hauppauge, N.Y.). Pressure flows were generated using a vacuum pump system (CENCO Hyvac, Fort Wayne, Ind.).

The coated paramagnetic beads were locally packed onto the fused silica capillary by the application of a strong magnetic field (2360 G at the channel wall) by a rare earth magnet (3/4 in. diameter, 0.1875 in. thick disk of NdFeB (27/30 mixed), rated at 11 lb. lift (Edmund Scientific, Barrington, N.J.; catalog no. CR35106)). The magnet was placed directly over the microchannel, and the paramagnetic particles were locally collated at the area of the steepest magnetic field gradient i.e., at leading edge of the magnet. The particles were conveyed through the system using vacuum-induced flows of 0.33 atmospheres for 30 seconds followed by 0.10 atmospheres for 5 to 10 minutes. Fluid flow in the channel was controlled either by application of a pressure gradient or through electroosmosis. A newly packed bed was used for each experiment. Typical packed bed lengths were approximately 2 to 3 mm in length (0.5 to 1.0 nL volume). After the initial packaging of the bed, both ends of the capillary were exposed to atmospheric pressure to equilibrate the system. To induce the structures, the magnet was removed to allow the particles to return to their colloidal state. Supra-particle patterns were immediately observed by placing the rare earth magnet 1 to 2 cm from the microchannel (˜500G).

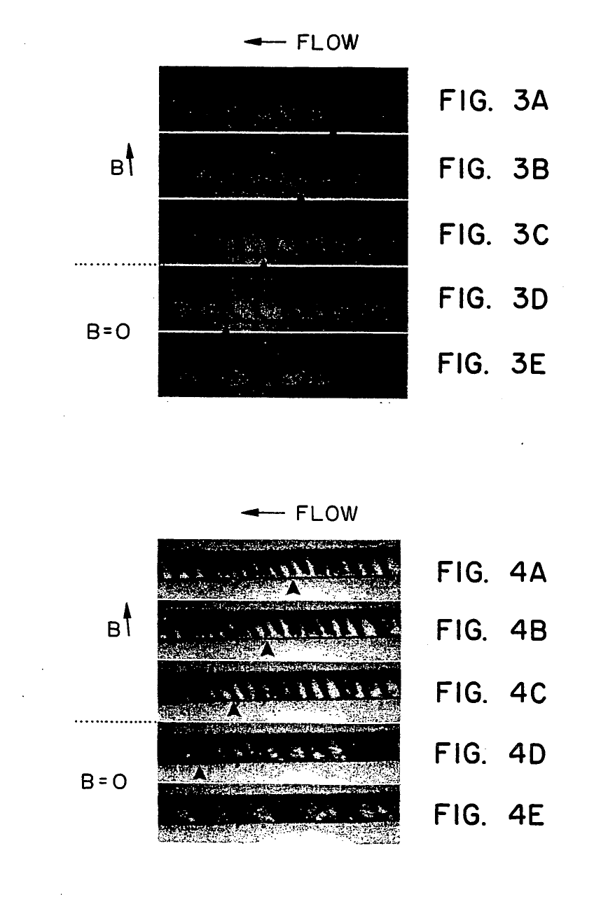

Optical microscopy was used to visualize the colloidal suspension and the induced structures and the data were recorded by both video and single-frame imaging. An Olympus 1X70 Inverted Research microscope (Tokyo, Japan) was used for imaging. Image acquisition in the packed bed areas was performed with an RS170 CCD camera (SCI Electronics, East Hartford, Conn.) integrated with National Instruments LabVIEW image acquisition software and an IMAQ PCI-1408 image acquisition board (National Instruments, Austin, Tex.). FIG. 2A shows a concentrated bed of paramagnetic particles in a dispersed colloidal suspension. This image was acquired without an induced magnetic field, and the bed extended well beyond the 110 μm length shown in this image. This high volume fraction colloid was free to move by pressure-induced flow or electrokinetic effects and Brownian motion of individual particles was observed. Upon application of an axially homogeneous magnetic field, where the field was approximately in the plane of the page and vertical, a columnar structure was immediately observed as shown in FIG. 2B. Altering the field orientation to be perpendicular to the page immediately resulted in the structures rotating such that the tops of the columns could be viewed as shown in FIG. 2C. As can be seen from FIG. 2C the structures tend to occupy the central portion of the channel, the caps appear to be cylindrical, and they are somewhat staggered rather than perfectly aligned with the centerline of the tube. Rotation of the field back to the plane of the page but at a 45-degree angle to the original resulted in structures lying parallel but off the vertical axis as shown in FIG. 2D. Further rotation to an orientation parallel with the axis of the channel resulted in a ropelike formation aligned down the center of channel axis as shown in FIG. 2E. It is energetically favorable for the paramagnetic particles to form a chain with a length many times greater than the particle diameter.

In contrast, the column length in the previous images FIGS. 2B and 2D, was limited by the channel walls, whereas no such limit exists with the field direction along the axis. Once the external magnetic field is removed as can be seen in FIG. 2F, the particles immediately begin diffusing and the structures are relaxed. All of the induced structures shown in FIGS. 2B-2E freely move when a pressure gradient or electrokinetic force is applied. The elapsed time between image acquisitions was between 1 and 5 seconds.

Periodic structures are often the result of competition among energies, wherein this case short range exchange interaction is competing with long range dipole energy. The formation of the columnar structures can be understood by examining actions of individual particles in the presence of an external field. The attraction (U) between two particles is given by:

U(D,θ)=(u²/4Πμ₀)(1−3 cos² θD³)

where θ is the angle between the line connecting the centers of the particles and the external field direction, μ₀ is the permeability of free space, D is the distance between the particle centers, and u is the induced dipole, 4/3Πr₉³χₚB where rₚ is the radius of the particle, χₚ the susceptibility of the particle, and B is the magnetic flux density. In the presence of an orienting external magnetic field, growing a one dimensional lattice by adding particles end-to-end is preferred at low particle concentrations since a larger negative free energy charge results. However, at higher concentrations a two-dimensional lattice of staggered rows of particles results which is observed as columns. Due to lateral attractive forces and size mismatch, these aggregations combine and form columns. Once formed, their poles are aligned and short range ordering is generated since the columns are repulsive to each other. In the present example microchannel system the columns reside primarily within the center of the microchannel with a staggered arrangement, as can be seen by the supraparticle columns in FIGS. 2B and 2C. For a given field strength, the characteristic spacing between columns is strongly influenced by the characteristic width of the container according to a power law relationship.

The transition from one pattern to the next due to magnet position and rotation occurs very rapidly, as fast as could be visualized. The retarding forces on the paramagnetic particles due to viscous drag or interactions with the wall of the cylindrical microchannel are much weaker than the local and induced magnetic forces. To understand this observation, it is informative to calculate the approximate drag forces versus the influence of reorientation of the external magnetic field. A relative measure of this is obtained by taking the ratio (Ξ) of the force on a paramagnetic particle due to an external field to the drag force according to

Ξ=(χₚ−χ₀)rₚ²∀B²/9ημₒUₚ

where Uₚ the velocity of the particle, and χₒ is the magnetic susceptibility and η the viscosity of the medium. Since a typical neodymium-iron-boron (NdFeB) magnet has a coercivity on the order of 10⁶ A/m, for a particle velocity of one millimeter per second Ξ is greater than 10⁴. This indicates that the magnetic force clearly dominates over drag forces in this system. This large field intensity provides the rapid response in particle patterning as the field changes, but does not lock the paramagentic particles in place. Because the field has no appreciable gradient in the axial dimension it allows the structures to retain their form while moving laterally under flow or electrokinetic effects as can be seen in the following example. There is no appreciable force from the induced magnetic field that must be overcome to move the structures in the axial direction.

Upon application of the axially-homogenous magnetic field the particles immediately form distinct columnar supraparticle structures. The basic structure pattern is a function of external field strength orientation, the container geometry and the colloid properties.

### EXAMPLE 2

### Effect of Pressure Induced Flow

The dilute colloidal suspension of coated paramagnetic particles within the cylindrical microchannel was placed under a pressure induced flow as shown in FIG. 3A. The flow was approximately 20 microns/second. Placing the dilute colloidal suspension of paramagnetic particles under a pressure induced flow generates laminar induced flows. Laminar induced flows result from the drag induced by the walls and create a significant change in fluid velocity across the radius of the channel. The highest velocity, twice the average velocity and therefore the highest force on the distinct columnar supraparticle structures occurs in the center of the channel and the lowest velocity occurs near the wall, i.e., a velocity of zero occurs at the wall. This creates shear stresses across the radius of the channel and therefore across the length of the distinct columnar supraparticle structures. As can be seen from FIG. 3A the structural integrity, induced by local and global magnetic fields, of the distinct columnar supraparticle structures is sufficient to resist deformation from the flow stresses and any drag effects generated by contact with the walls.

FIG. 3B illustrates an image of the cylindrical microchannel containing the dilute colloidal suspension of paramagnetic particles taken at a time slightly later than the image in FIG. 3A. The image in FIG. 3B depicts the same 110 micrometer length as shown in the FIG. 3A. The axially-homogenous magnetic field is oriented in the same direction as it was when the image in FIG. 3A was taken. As can be seen from FIG. 3B the distinct columnar supraparticle structures move in direction of the pressure induced flow without distortion.

FIG. 3C illustrates an image of the cylindrical microchannel containing the dilute colloidal suspension of paramagnetic particles taken at a time slightly later than the image shown in FIG. 3B. The image in FIG. 3C depicts the same 110 micrometer length as shown in the images in FIGS. 3A and 3B. The axially-homogenous magnetic field is oriented in the same direction as it was when the images in FIGS. 3A and 3B were taken. As can be seen from FIG. 3C, the distinct columnar supraparticle structures continue to move in the direction of the pressure induced flow without distortion.

FIG. 3D illustrates an image of the cylindrical microchannel containing the dilute colloidal suspension of paramagnetic particles taken at a time slightly later than the image of FIG. 3C. The image in FIG. 3D depicts the same 110 micrometer length as shown in the images in FIGS. 3A-C. The axially-homogenous magnetic field was removed from the cylindrical microchannel at a time slightly before the image in FIG. 3D was taken. As can be seen from FIG. 3D, immediately upon removal of the axially-homogenous magnetic field, the columnar structures begin to break down. The shear stresses exerted on the columnar structures from the laminar flow profile become apparent as each of the individual paramagnetic particles assume the local fluid velocity. The particles in the middle of the channel travel at a higher rate than those at or near the wall which are relatively impeded.

FIG. 3E is an image of the cylindrical microchannel containing the dilute colloidal suspension of paramagnetic particles taken at a time slightly later than the image in FIG. 3D. The image in FIG. 3E was taken of the same 110 micrometer length as shown in the images in FIGS. 3A-3D, using optical microscopy. Approximately one second passed between the time the image in FIG. 3D was taken and the image in FIG. 3E was taken. As can be seen in FIG. 3E, the particles have begun to resume a colloidal state within one second of the removal of the axially-homogenous magnetic field.

### Example 3

### Electrokinetic Effects

FIG. 4A illustrates an image of a cylindrical microchannel containing a dilute i.e., less than 0.1% solids weight to volume, colloidal suspension of paramagnetic particles. The image is taken using optical microscopy. The microchannel was filled with a dilute colloidal suspension of coated paramagnetic particles in buffer as described in Example 1.

The dilute colloidal suspension of paramagnetic particles within the cylindrical microchannel was placed under an axially-homogenous magnetic field with no appreciable gradient oriented slightly to the left of vertical, parallel with the plane of the page. An arrow shows the direction of the magnetic field as being forty five degrees slightly to the left of vertical, parallel with the plane of the page. The axially-homogenous magnetic field is generated by a rare earth magnet field strength of 1/20 Tesla or 500 Gauss. The axially-homogenous magnetic field does not have an appreciable gradient in the axial direction of the microchannel.

Upon application of the axially-homogenous magnetic field the particles immediately formed distinct columnar supraparticle structures. The basic structure pattern is a function of external field strength orientation, the container geometry and the colloid properties. The increased concentration of paramagnetic particles in the dilute colloidal suspension of paramagnetic particles caused the spaces between the distinct columnar supraparticle structures to appear smaller and more cloudy.

An applied potential field was applied along the axis of the cylindrical microchannel. The applied potential field generated electrokinetic movement of the distinct columnar supraparticle structures. The movement was approximately 20 microns/second generated by both electrokinetic and electrophoresis effects. Electrokinetic effects use a different mechanism to create movement than does pressure induced flow. Electroosmosis generates a plug-like flow profile and the velocity is the same at all radii. Electrophoretic forces act directly on the particles themselves since they are positively charged.

FIG. 4B illustrates an image of the cylindrical microchannel containing the dilute colloidal suspension of paramagnetic particles taken at a time slightly later than the image in FIG. 4A. The image depicts the same 110 micrometer length as shown in the image in FIG. 4A. The axially-homogenous magnetic field is oriented in the same direction as it was when the image in FIG. 4A was taken, and the applied potential field is present. As can be seen from FIG. 4B, the columnar structures move in the direction of the electrokinetic effects without distortion.

FIG. 4C illustrates an image of the cylindrical microchannel containing the dilute colloidal suspension of paramagnetic particles taken at a time slightly later than the image in FIG. 4B. The image in FIG. 4C depicts the same 110 micrometer length as shown in the images in FIGS. 4A and 4B. The intense axially-homogenous magnetic field is oriented in the same direction as it was when the images in FIGS. 4A and 4B were taken, and the applied potential field is present. The columnar structures continue to move in direction of the electrokinetic effects without distortion. As can be seen from FIGS. 4A-4C the columns move at a velocity defined by the additive forces of electrophoresis and electroosmosis but the structures remain intact and are not deformed by this movement. The observed electrophoretic migration rate of the columnar structures was 4×10⁴ cm²/Vs.

FIG. 4D illustrates an image of the cylindrical microchannel containing the dilute colloidal suspension of paramagnetic particles taken at a time slightly later than the image in FIG. 4C. The image depicts the same 110 micrometer length as shown in the images in FIGS. 4A-4C. The intense axially-homogenous magnetic field is no longer applied to the cylindrical microchannel, but the applied potential field is present. Upon removal of the axially-homogenous magnetic field, the electrokinetic effects still move the individual particles such that the columnar structures begin to break down at the same rate they would if there was no flow in the cylindrical microchannel. No distinct flow pattern was observed after the axially-homogenous magnetic field is removed because the electrokinetic effects are equivalent across the radius of the channel of the cylindrical microchannel.

FIG. 4E illustrates an image of the cylindrical microchannel containing the dilute colloidal suspension of paramagnetic particles taken at a time slightly later than the image in FIG. 4D. The image was taken of the same 110 micrometer length as shown in the images in FIGS. 4A-4D, using optical microscopy. Approximately one second passed between the time the image in FIG. 4E was taken and the image in FIG. 4D was taken. The particles began to resume a colloidal state within one second of the removal of the axially-homogenous magnetic field but no distinct flow pattern was observed because the electrokinetic effects are equivalent across the radius of the 20 μm channel.

### Example 4

### Effect of Microchannel Geometry

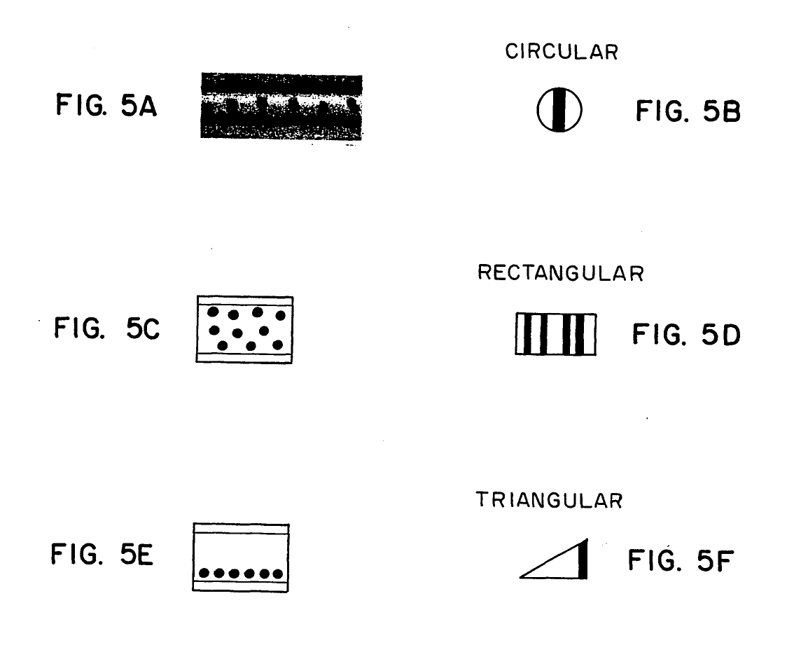

FIG. 5A illustrates an image 400 of the cylindrical microchannel containing the dilute colloidal suspension of paramagnetic particles. The dilute colloidal suspension of paramagnetic particles within the cylindrical microchannel was placed under an axially-homogenous magnetic field with no appreciable gradient oriented perpendicular to the plane of the page. The intense axially-homogenous magnetic field was generated by a rare earth magnet having a field strength of 1/20 Tesla or 500 Gauss. The axially-homogenous magnetic field does not have an appreciable gradient in the axial direction of the microchannel. A dot shows the direction of the magnetic field as perpendicular to the plane of the page.

Upon application of the axially-homogenous magnetic field the particles immediately formed distinct columnar supraparticle structures. The distinct columnar supraparticle structures formed across the central axis of the cylindrical microchannel, which is the widest portion of the cylindrical microchannel, parallel with the axially-homogenous magnetic field.

FIG. 5B illustrates a hypothetical image of a cross-section of the cylindrical microchannel containing a colloidal suspension of paramagnetic particles. Upon application of the axially-homogenous magnetic field the particles immediately form the distinct columnar supraparticle structure. An arrow shows the direction of the magnetic field as being vertical, parallel with the plane of the page. The distinct columnar supraparticle structure should form across the widest portion of the cylindrical microchannel, parallel with the axially-homogenous magnetic field.

FIG. 5C illustrates a hypothetical image of a hypothetical triangular microchannel containing a colloidal suspension of paramagnetic particles. The triangular microchannel has a triangular cross-section. The microchannel is filled with a dilute colloidal suspension of paramagnetic particles. The dilute colloidal suspension of paramagnetic particles within the triangular microchannel is placed under an axially-homogenous magnetic field with no appreciable gradient oriented perpendicular to the plane of the page. The intense axially-homogenous magnetic field is generated by a rare earth magnet. The intense axially-homogenous magnetic field does not have an appreciable gradient in the axial direction of the microchannel. A dot shows the direction of the magnetic field as perpendicular to the plane of the page.

Upon application of the intense axially-homogenous magnetic field the particles should immediately form distinct columnar supraparticle structures. The distinct columnar supraparticle structures should form across the widest portion of the triangular microchannel, parallel with the axially-homogenous magnetic field.

FIG. 5D illustrates a hypothetical image of a cross-section of the triangular microchannel containing a colloidal suspension of paramagnetic particles. Upon application of an axially-homogenous magnetic field the particles should immediately form a distinct columnar supraparticle structure. An arrow shows the direction of the magnetic field as being vertical, parallel with the plane of the page. The distinct columnar supraparticle structure should form across the widest portion of the triangular microchannel, parallel with the intense axially-homogenous magnetic field.

FIG. 5E illustrates a hypothetical image of a hypothetical rectangular microchannel containing a dilute colloidal suspension of paramagnetic particles. The rectangular microchannel has a rectangular cross-section. The microchannel is filled with the dilute colloidal suspension of paramagnetic particles. The dilute colloidal suspension of paramagnetic particles within the rectangular microchannel is placed under an intense axially-homogenous magnetic field with no appreciable gradient oriented perpendicular to the plane of the page. The intense axially-homogenous magnetic field is generated by a rare earth magnet. The intense axially-homogenous magnetic field does not have an appreciable gradient in the axial direction of the microchannel. A dot shows the direction of the magnetic field as perpendicular to the plane of the page.

Upon application of the axially-homogenous magnetic field the particles should immediately form distinct columnar supraparticle structures. The distinct columnar supraparticle structures should form across the widest portion of the rectangular microchannel. When the high magnetic filed is oriented perpendicularly with two of the sides of the rectangular microchannel, the distinct columnar supraparticle structures should separate regularly based upon column-column repulsion.

FIG. 5F illustrates an image of a cross-section of the rectangular microchannel containing the colloidal suspension of paramagnetic particles. Upon application of the axially-homogenous magnetic field the particles should immediately form distinct columnar supraparticle structure. An arrow shows the direction of the magnetic field as being vertical, parallel with the plane of the page. The distinct columnar supraparticle structures should form across the widest portion of the rectangular microchannel, parallel with the intense axially-homogenous magnetic field.

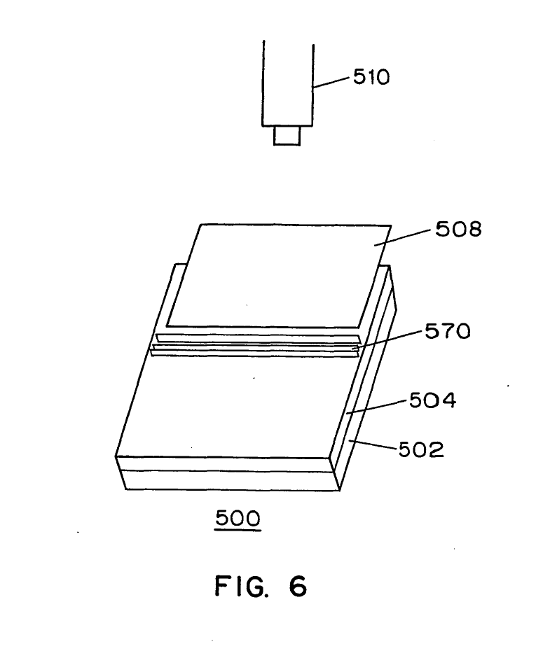

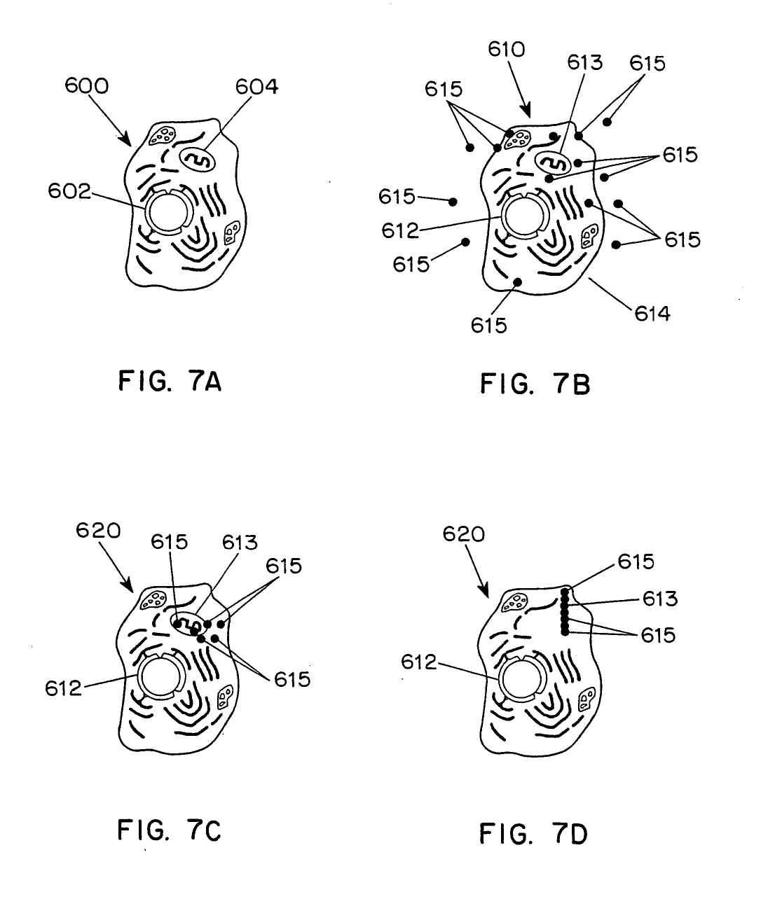

The orientation of the columns and the ability to form parallel lines and other morphologies can lead to a unique method for creating inexpensive, and dynamic photon masks. FIG. 6 illustrates a photon mask apparatus 500. A photon reactive flat substrate 502 could be patterned by passing a laser 510 through a series of microchannels 506 and a flat substrate 504 that is photon permeable where paramagnetic particles, which are not photon permeable, are oriented based on the orientation of a magnetic field generated by a magnet 508. The series of microchannels 506 can be used as a dynamic mask to control the spatial location of light irradiation to the photon reactive flat substrate 502. A series of chip-based electromagnets located in the microdevice can be controlled to alter the field strength and direction, therefore altering the micropatterns within the series of microchannels 506. This would allow polymerization of the photon reactive flat substrate 502 to be initiated and maintained by photons and to be spatially controlled within a small volume, static environment or a small volume, microfluidic environment.

The photon mask apparatus 500 will allow micrometer to nanometer-scale photon reactive flat substrates to be manufactured in such a microdevice depending, in part, upon the size of paramagnetic particles employed. Aspect ratios of the polymer can be controlled by adjusting the relative flow rate in the series of microchannels 506 or by flowing polymer reaction solution. In a certain embodiment, the interference patterns of the laser beam 510 passing the series of microchannels 506 can also be changed dynamically thus producing a dynamic grating system. This system can also be used as a dynamic photon mask for a substrate placed directly beneath the chip. In this manner, the patterns created by the claimed invention provides for microchip fabrication.

In an alternate embodiment, the spacing and structure within the group of microchannels could be made consistent with photon band gap material and could provide a mechanism to make dynamic actuators for this purpose.

The present invention can also be used in biological application as shown in FIG. 6. FIG. 6A illustrates a prior art biological cell 600. The cell 600 includes a nucleus 602 and mitochondria 604. FIG. 6B illustrates a cell 610 that has been introduced to an aqueous suspension of paramagnetic particles. An aqueous suspension of paramagnetic particles 614 is introduced to the cell 610 with a nucleus 612 and mitochondria 613. The aqueous suspension of paramagnetic particles 614 includes a group of paramagnetic particles 615. The group of paramagnetic particles 615 are coated with immobilized antibodies to mitochondrial surface proteins. The group of paramagnetic particles 615 is imbibed by the cell through the temporary disruption of the cell membrane using a calcium phosphate solution. Depending upon the diameter of each of the group of paramagnetic particles 615 and the volume fraction of the aqueous suspension of paramagnetic particles 614, the number of particles introduced can vary.

FIG. 6C illustrates a cell 620 that has been introduced to the group of paramagnetic particles 615 for a period of time. At least a portion of the group of paramagnetic particles 615 that are coated with immobilized antibodies to mitochondrial surface proteins bind to the mitochondria 613, at least in part.

FIG. 6D illustrates a cell 630 with mitochondria that has bonded with at least a portion of the group of paramagnetic particles and has been placed under a magnetic field. An external magnetic field is applied to the cell 630. The magnetic field causes the group of paramagnetic particles 615 to assume a columnar shape and therefore distort the shape of the mitochondria 613.

Distorting the shape of certain cellular structures can be used to study subcellular biomechanics or to study the effects of intracellular shear forces on cells. Sub-cellular mixing could also be done in this fashion by introducing other types of binding particles that would bond with different cellular structures. The advantage of mixing from within is in using smaller fluid volumes than currently needed in bulk homogenization techniques along with minimizing the time and energy for homogenization—thus improving the yield of active biopolymers.

In one embodiment, the magnetic field that creates the columnar structures is altered causing the columnar structures formed within the microchannels to move. The movement of the columnar structures can be used to induce convective currents in picoliters and femtoliters. In yet another embodiment, the columnar structures in microchannels can be used to control short life time intermediate interactions, for example, singlet oxygen, among the paramagnetic particles since the lifetime of singlet oxygen will change upon interaction with structures.

In another embodiment, the spacing and structure of columnar structures can be made consistent with photon band gap material and therefore a dynamic actuator is possible. Also, the line spacing could be dynamically controlled over a considerable range by field strength and/or replacement of the particles by flow to generate ensemble chromatic effects thus generating a tunable and dynamic grating/interface optical systems.

1. A method of assembling particles to form a pattern of structures in a microchannel comprising:
providing a plurality of paramagnetic particles in a microchannel; and
subjecting the microchannel to an external magnetic field wherein the paramagnetic particles assemble to form the pattern of structures.

2. A method of assembling particles according to claim 1 wherein the external magnetic field is substantially uniform in the axial direction of the microchannel.

3. A method of assembling particles according to claim 1 further comprising rotating the structures in the microchannels by varying the magnetic field.

4. A method according to claim 1 wherein the particles assemble to form a pattern of columnar structures.

5. A method according to claim 1 wherein each of the columnar structures has a diameter of up to 6 μm.

6. The method of claim 1, wherein the plurality of paramagnetic particles are in a colloidal suspension in the microchannel.

7. The method of claim 6, wherein the dilute colloidal suspension comprises an aqueous phosphate buffer at pH=7.

8. The method of claim 1, wherein each of the plurality of paramagnetic particles is greater than one micrometer in diameter.

9. The method of claim 1, wherein each of the plurality of paramagnetic particles is less than two micrometers in diameter.

10. The method of claim 1, wherein each of the plurality of paramagnetic particles is coated with an amine functional group.

11. The method of claim 1, wherein the microchannel has an internal diameter of 20 micrometers.

12. The method of claim 1, wherein the microchannel is made of fused silica.

13. The method of claim 1, further comprising the step of altering the orientation of the columnar structures of paramagnetic particles in the microchannel by altering the orientation of the external magnetic field.

14. An apparatus adapted to create variable structures in a microchannel, comprising:
a microchannel, the microchannel containing a plurality of paramagnetic particles; and
a magnet external to the microchannel.
